(19) United States
(12) Patent Application Publication
(10) Pub. No.: US 2026/0285665 A1
(43) Pub. Date: Sep. 24, 2026

(54) MANIPULATOR FOR OPENING AND FOR CLOSING A SWINGING COVER FOR A MANHOLE OF A STEAM GENERATOR AND ASSOCIATED OPENING AND CLOSING METHODS

(71) Applicant: Pilgrim International Ltd., Oldham (GB)

(72) Inventor: David CHARLES, Oldham (GB)

(21) Appl. No.: 19/564,398

(22) Filed: Mar. 12, 2026

(30) Foreign Application Priority Data
Mar. 21, 2025 (DE) 102025110944.3

(51) Int. Cl. B66F 19/00

(52) U.S. Cl. CPC B66F 19/005

(57) ABSTRACT

A manipulator for opening and closing a swinging cover of a manhole of a steam generator includes a hand trolley assembly and a winch assembly detachably mounted to the hand trolley assembly. The winch assembly includes a winch having a pair of wires, a pair of hooks for hanging the winch assembly on an axle of the swinging cover, and two threaded anchors, each anchor being attached to an end of one of the wires and being intended to pass through a first through hole of the swinging cover and to be threaded into a threaded second hole provided on a base plate of the steam generator so as to provide a support point for the associated wire. The winch is adapted to wind and unwind the wires in order to rotate the swinging cover between a closed cover position and an open cover position.

### CROSS-REFERENCE

This application claims priority to German patent application no. 102025110944.3 filed on Mar. 21, 2025, the contents of which are fully incorporated herein by reference.

### BACKGROUND OF THE INVENTION

The present invention relates to steam generators, and more particularly to a manipulator for opening and for closing a cover for a manhole of a steam generator for nuclear power stations and associated methods of opening and closing of such a cover.

In nuclear power plants using Pressurized Water Reactor or PWR technology, heat is provided by an intermediate heat transfer fluid which transfers heat from a nuclear reactor core to a steam generator.

Periodically, it is necessary to gain access to the interior of such steam generators, for example to carry out checking and maintenance operations.

Access is gained by means of the opening of manholes.

Outside checking and maintenance operations, each manhole is closed by a cover that ensures the watertightness of the steam generator.

Usually, such a cover is heavy and it is difficult for the maintenance personnel to manipulate the cover during the opening and closing of the manholes.

Furthermore, it is often required to minimize the downtime.

However, in the prior art the positioning of the cover relative to the steam generator is not very precise and the maintenance personnel has to spend time in order to obtain a correct position.

In addition, it is often required to keep the opened cover as close as possible to the steam generator.

Therefore, there is a need to provide a solution for opening and closing a cover for a manhole of a steam generator that meets the above requirements and which makes it possible to ensure a swift and precise manipulation of the cover during both opening and closing of the manhole.

### SUMMARY OF THE INVENTION

The present invention relates to a manipulator for opening and for closing a swinging cover for a manhole of a steam generator. The manipulator comprises a hand trolley assembly and a winch assembly detachably mounted to the hand trolley assembly and comprising a winch provided with a pair of wires. The winch assembly is intended to engage the swinging cover and is further provided with a pair of hooks intended to hang the winch assembly on an axle of the swinging cover and with two threaded anchors, each anchor being attached to an end of one of the wires and being intended to pass through a first through hole of the swinging cover and to be threaded to an inner thread of a second hole provided on a base plate of the steam generator so as to provide a support point for the associated wire. The winch is adapted to wind up and wind out the wires in order to rotate the swinging cover between a closed cover position in which the first through hole is aligned with the second hole and an open cover position in which the swinging cover is at a neutral hanging point.

The manipulator allows opening and closing the manhole cover in a safe and controlled manner that minimizes the downtime.

Preferably, the winch assembly is further provided with location means intended to cooperate with associated receiving means provided on the swinging cover so as to ensure a correct position of the winch assembly with respect to the swinging cover.

For example, the location means comprise a pair of location cones and the receiving means comprise a pair of second through holes provided between the axle and the first through holes, each location cone being intended to be inserted in one second through hole.

In some embodiments, each hook comprises a body and a rotatably mounted jaw movable between an open and a closed position, the body and the jaw delimiting together an oblong transverse opening when the jaw is in the closed position.

Preferably, the manipulator further comprises wire guiding means associated with each one of the wires.

For example, the wire guiding means comprise a pair of jockey wheels associated with each one of the wires and provided on a frame of the winch assembly.

In a set of embodiments, the wire guiding means comprise a cover wire guide and a base plate wire guide detachably mounted respectively on the cover and on the base plate.

Advantageously, the hand trolley assembly is provided with lifting means adapted to displace vertically the winch assembly.

According to another aspect of the invention, there is provided a method for opening a closed swinging cover with a manipulator as defined above. The method comprises following steps:
approaching the cover axle with the manipulator;
hanging the winch assembly on the cover axle;
detaching the winch assembly from the hand trolley assembly;
pulling the wires through the cover and threading the anchors to the base plate;
winding up the wires to lift the winch assembly to the cover until the winch assembly engages the cover;
complete unfastening of the cover from the base plate;
winding out the wires to lower the cover until reaching a neutral hanging point corresponding to an open cover position;
winding out the wires to full de-tensioning and removing the anchors from the base plate and winding up the wires on the winch; and
removing the winch assembly with the hand trolley assembly.

According to another aspect of the invention, there is provided a method for closing an open swinging cover with a manipulator as defined above. The method comprises following steps:
approaching the cover with the manipulator;
engaging the cover with the winch assembly;
hanging the winch assembly on the cover axle;
detaching the winch assembly from the hand trolley assembly;
pulling the wires through the cover and threading the anchors to the base plate;
winding up the wires in order to lift the cover to the closed cover position;
short-term fastening of the cover to the base plate in the closed cover position;
winding out the wires to full de-tensioning to lower the winch assembly from the cover;
removing the anchors from the base plate and retracting the wires on the winch;
removing the winch assembly with the hand trolley assembly; and
long-term fastening of the cover to the base plate.

### BRIEF DESCRIPTION OF THE SEVERAL VIEWS OF THE DRAWINGS

The present invention and its advantages will be better understood by studying the detailed description of specific embodiments given by way of a non-limiting examples and illustrated by the appended drawings on which:

FIG. 1 is a perspective view of a manipulator according to an example of the invention;

FIG. 2 is a side view of the manipulator of FIG. 1;

FIG. 3 is a detail side view of a winch assembly of the manipulator of FIG. 1 when engaging a cover;

FIG. 4 is a side view of a hand trolley assembly of the manipulator of FIG. 1, in a low position;

FIG. 5 is the hand trolley assembly of FIG. 4, in a high position;

FIG. 6 is a perspective view of a cover wire guide of the manipulator of FIG. 1, when clamped on a cover;

FIG. 7 is a perspective view of a base plate wire guide of the manipulator of FIG. 1, when clamped on a base plate;

FIG. 8 is a flow diagram of a method for opening a closed swinging cover with the manipulator of FIG. 1;

FIGS. 9-12 and 14-17 schematically illustrate certain steps of the method of FIG. 8;

FIG. 13 is a front view of the cover of FIGS. 9-12 and 14-17;

FIG. 18 is a flow diagram of a method for closing an open swinging cover with the manipulator of FIG. 1; and

FIGS. 19-24 schematically illustrate certain steps of the method of FIG. 18.

### DETAILED DESCRIPTION OF THE INVENTION

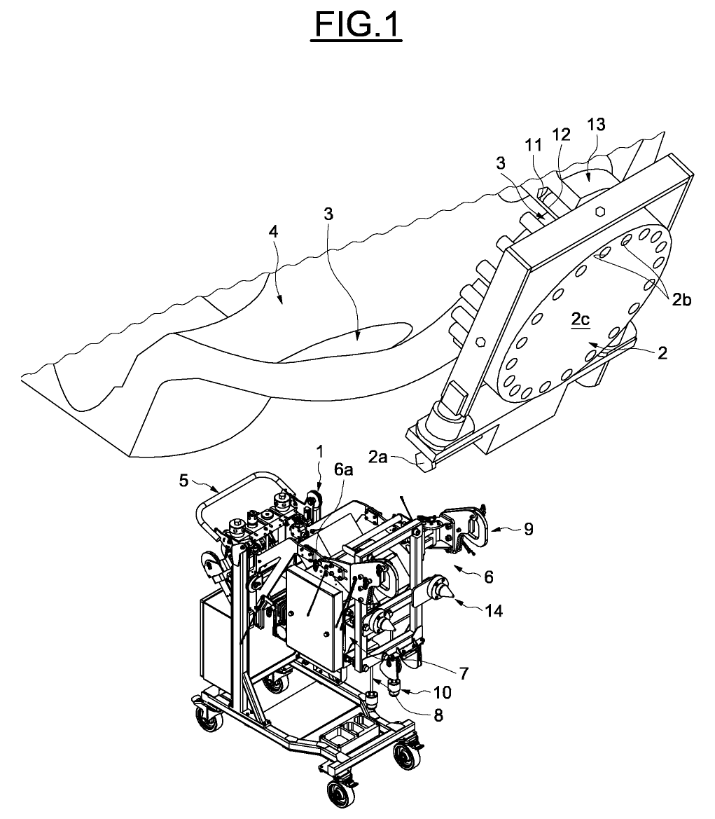

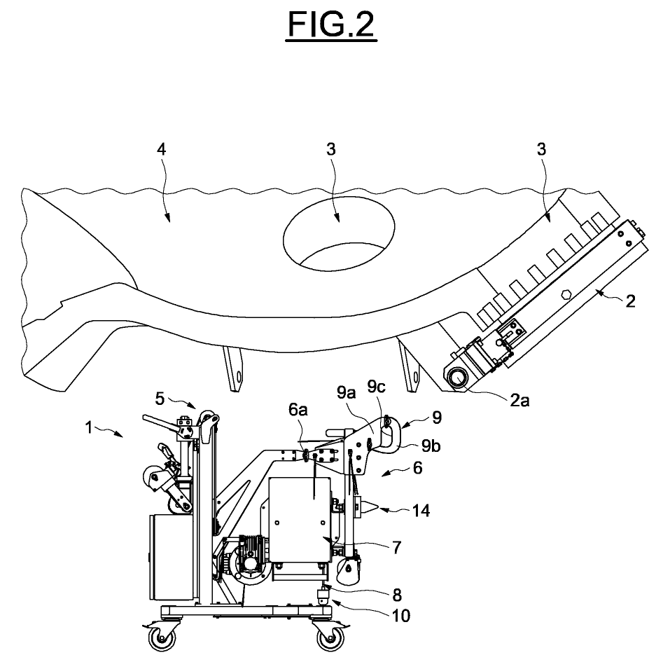

A manipulator 1 is represented on FIGS. 1 and 2 and is adapted to open and to close a cover 2 for a manhole 3 of a steam generator 4 of a nuclear plant.

The cover 2 is configured to rotate around an axle 2a between a closed cover position and an open cover position. The axle 2a is fixed to the steam generator 4 and is essentially coplanar with the cover 2.

The manipulator 1 comprises a hand trolley assembly 5 and a winch assembly 6.

The winch assembly 6 is detachably mounted to the hand trolley assembly 5, for example with a pair of removable ball lock pins 6a that allow the winch assembly to rotate freely. The winch assembly 6 includes a winch 7 provided with a pair of wires 8. The winch assembly 6 is intended to engage the swinging cover 2 and is further provided with a pair of hooks 9 intended to hang the winch assembly 6 on the axle 2a. The winch assembly 6 is provided with two threaded anchors 10, each anchor 10 being attached to an end of one of the wires 8 and being intended to pass through a first through hole 2b of the swinging cover 2 and to be fastened to an inner thread 11 of a second hole 12 provided on a base plate 13 of the steam generator 4 so as to provide a support point for the associated wire 8.

For example, the fastening and unfastening of the anchors 10 is made with a screwing tool (not shown) provided with a head and an elongated body. The head is provided with at least two fingers that cooperate with a plurality of associated holes provided on each anchor 10. Once the fingers are inserted in the associated holes, this allows the joint rotation of the screwing tool and the anchor 10. The elongated body has a central part and a tail.

The screwing tool is provided with a slot provided over the entire length of the screwing tool in order to receive the wire 8 associated with the anchor 10 inside the screwing tool. The length of the screwing tool is such that when the fingers are inserted in the associated holes of the anchor 10, the elongated body extends through the width of the cover 2 with the tail protruding out of the cover 2.

The winch 7 is adapted to wind up and to wind out the wires 8 in order to rotate the swinging cover 2 around the axle 2a between the closed cover position in which the first through hole 2b is aligned with the second hole 12 and the open cover position in which the swinging cover 2 is at a neutral hanging point.

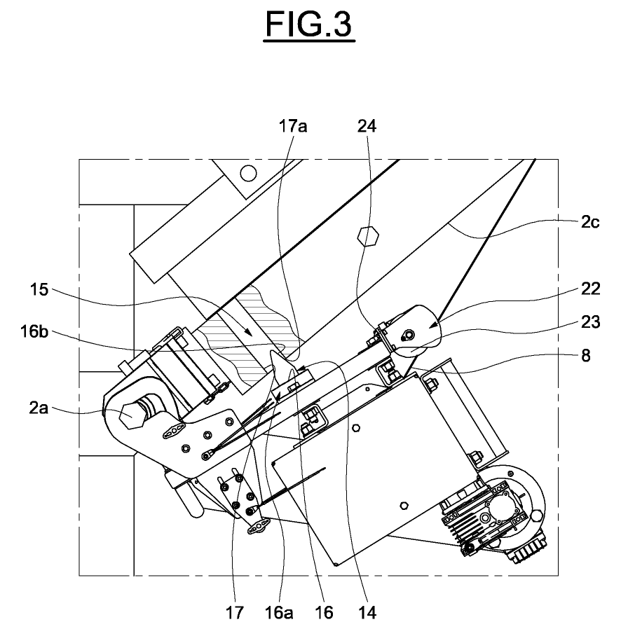

The winch assembly 6 is further provided with location means 14. As particularly shown in FIG. 3, the location means 14 cooperate with associated receiving means 15 provided on the swinging cover 2 so as to ensure a correct position of the winch assembly 6 with respect to the swinging cover 2.

It is to be noted that elements that are similar or identical are identified with the same references throughout the different figures.

As illustrated in FIG. 3, the location means 14 may comprise a pair of location cones 16 having base plates 16a. The receiving means 15 may comprise a pair of second through holes 17 provided between the axle 2a and the first through holes 2b. Each location cone 16 is inserted in one of the second through holes 17 and comes into contact with the bore 17a of the corresponding second through hole 17 as the winch assembly 6 engages the cover 2. When the location cones 16 are fully engaged in the second through holes 17, the base plates 16a contact the outer face 2c of the cover 2.

As shown more clearly in FIG. 2, each hook 9 comprises a body 9a and a rotatably mounted jaw 9b movable between an open and a closed position. The body 9a and the jaw 9b delimit together or define an oblong transverse opening 9c when the jaw 9b is in the closed position. The oblong transverse opening 9c contributes to the correct positioning of the winch assembly 6 with regard to the cover 2 as the oblong transverse opening 9c allows both translation and rotation in relation to the axle 2a as the winch assembly 6 engages the cover 2 (FIG. 3). This feature allows the winch assembly 6 to be pushed into a correct position as an outer surface 16b of each location cone 16 abuts against the corresponding bore 17a. Furthermore, the oblong transverse openings 9c allow a cover 2 slide up, when the base plates 16a contact the outer face 2c of the cover 2, allowing a correct alignment of the cover 2 in respect with base plate 13 of the steam generator 4. It is then easy to screw two short-term fastenings to hold the cover 2 in place before removing the winch assembly 6. The cover 2 slides up using a lever or pushing means such as a hydraulic ram.

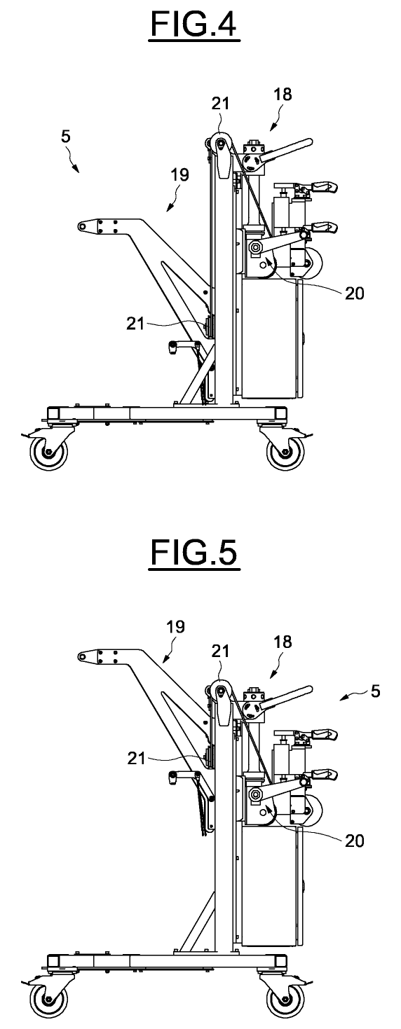

The hand trolley assembly 5 is provided with lifting means 18 adapted to displace vertically a pair of arms 19 between a low position and a high position shown respectively in FIGS. 4 and 5. Each arm 19 defines a lifting point 19a at which the winch assembly 6 is detachably mounted. The ability of displacing vertically the arms 19 enables the manipulator 1 to conveniently hoist the winch assembly 6 in the high position where it can hook the axle 2a and to lower the winch assembly 6 as needed for hanging or for stowing purposes. For example, the lifting means 18 may comprise a winch lifter 20 associated with a series of pulleys 21 (FIG. 4).

The manipulator 1 further comprises wire guiding means 22 associated with each of the wires 8. The wire guiding means 22 control the position of the wires 8 and protect the structural integrity of the wires 8 and of the elements in the vicinity of the wires 8, such as the cover 2 and the base plate 13, against rubbing or unwanted contact with the wires 8.

As particularly visible on the example shown in FIG. 3, the wire guiding means 22 comprise a pair of jockey wheels 23 associated with each one of the wires 8 and provided on a frame 24 of the winch assembly 6.

For example, the wire guiding means 22 comprise a cover wire guide 25 and a base plate wire guide 26 detachably mounted respectively on the cover 2 and on the base plate 13. The cover wire guide 25 prevents the wires 8 touching the cover 2 during the complete motion of the cover 2.

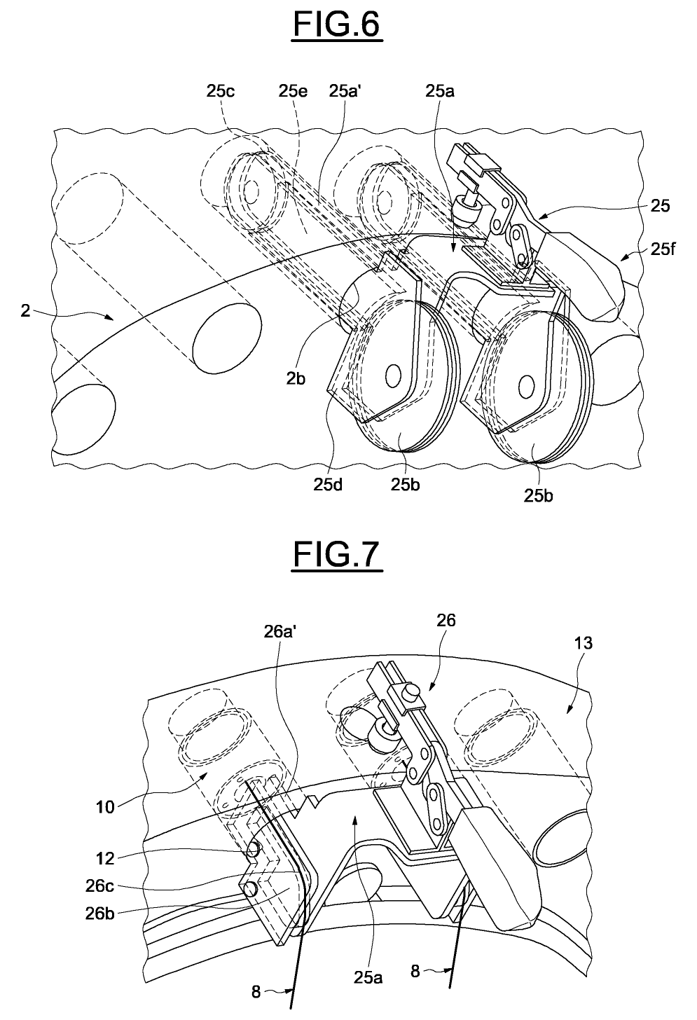

As shown in FIG. 6, the cover wire guide 25 comprises a main bracket 25a, two arms 25a’, a pair of main rollers 25b and a pair of front rollers 25c. The main bracket 25a is prolonged with two arms 25a’ extending between the main rollers 25b and the front rollers 25c. The front rollers 25c and main rollers 25b are mounted respectively at the free end of the arms 25a’ and at the main bracket 25a, for example on needle bearings.

The cover wire guide 25a further comprises a pair of outer guide plates 25d extending between the main rollers 25b and the front rollers 25c. The main rollers 25b and the front rollers 25c are sandwiched between the outer guide plates 25d and respectively the main bracket 25a and the arms 25a’.

The cover wire guide 25 further comprises a pair of spacer plates 25e sandwiched between the outer guide plates 25d and the main bracket 25a and the arms 25a’. Each spacer plate 25e is provided between the front rollers 25c and the main rollers 25b. Preferably, each spacer plate 25e is made of a material having a lesser hardness than the material of the wires 8 so as to protect the durability of the wires 8. For example, the spacer plates 25e may be made of nylon.

The main bracket 25a and the arms 25a’ are assembled together with the spacer plates 25e and the outer guide plates 25d, for example with nuts and bolts.

The cover wire guide 25 further comprises an over center clamp 25f that allows clamping on the cover 2. Just before clamping, the front rollers 25c, the outer guide plates 25d and the spacer plates 25e are inserted in the first through holes 2b, then the over center clamp 25f is used to clamp the cover wire guide 25 to the cover 2.

As shown in FIG. 7, the base plate wire guide 26 comprises a main bracket 26a, two arms 26a’, a pair of wire guide plates 26b and a pair of outer guide plates 26c. The wire guide plates 26b are sandwiched between the outer guide plates 26c and the main bracket 26a and the arms 26a’. The main bracket 26a and the two arms 26a’ are assembled together with the wire guide plates 26b and with the outer guide plates 26c, for example with nuts and bolts. The base plate wire guide 26 specifically protects the base plate 13 by preventing any unwanted contact between the wires 8 and the base plate 13, for example when the cover 2 is lowered to the open cover position.

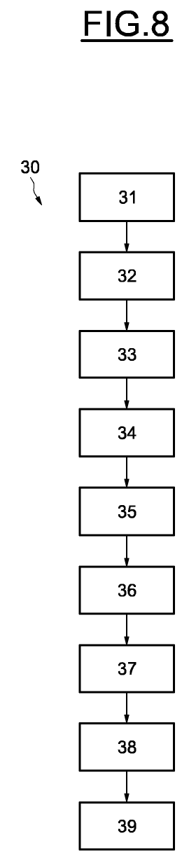

FIG. 8 is a flow diagram illustrating a method 30 for opening a closed swinging cover 2 using the manipulator 1 described above.

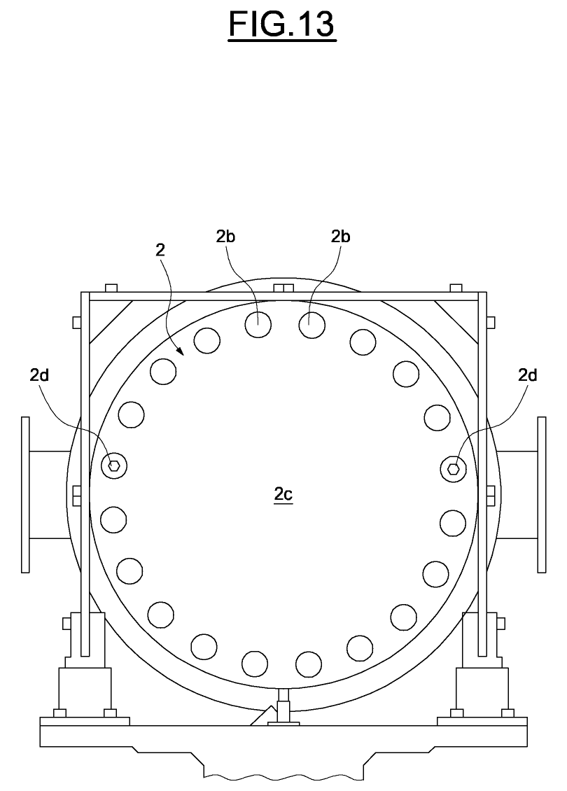

It is to be noted that prior to opening the closed swinging cover 2, all long-term fastenings of cover 2 to the base plate 13 are replaced with short-term fastenings. That means that all cover long-term fasteners (typically studs) that sit inside winch assembly 6 footprint or wire 8 path are removed and that the cover 2 is momentarily kept in place with the aid of short-term fastening, preferably with two centering tools 2d as shown in FIG. 13. The alternative meanings “short-term” and “long-term” are intended to discriminate between a temporary fastening of the cover used during maintenance and a definitive fastening used during operation of the steam generator. The temporary fastening can be rapidly realized without using special tensioning material; it allows the elements to be relatively fixed but it does not guarantee stability over time. Instead the definitive fastening, which is stronger than the previous one, is able to withstand the regular stress that the cover is exposed to in the course of the steam generator operation.

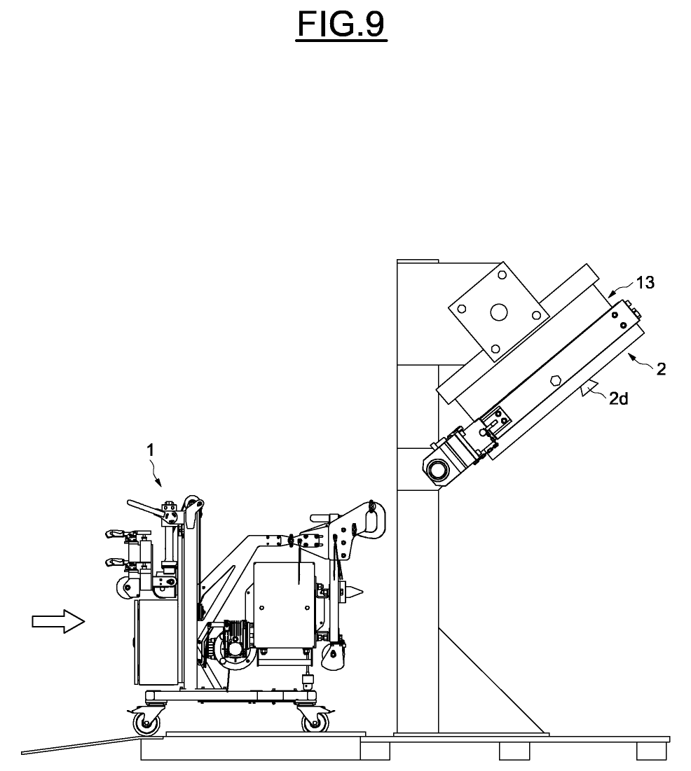

At step 31, the manipulator 1 approaches the cover axle 2a until being located proximal thereto, as shown in FIG. 9. Step 31 includes hoisting the winch assembly 6 to the high position with the lifting means 18.

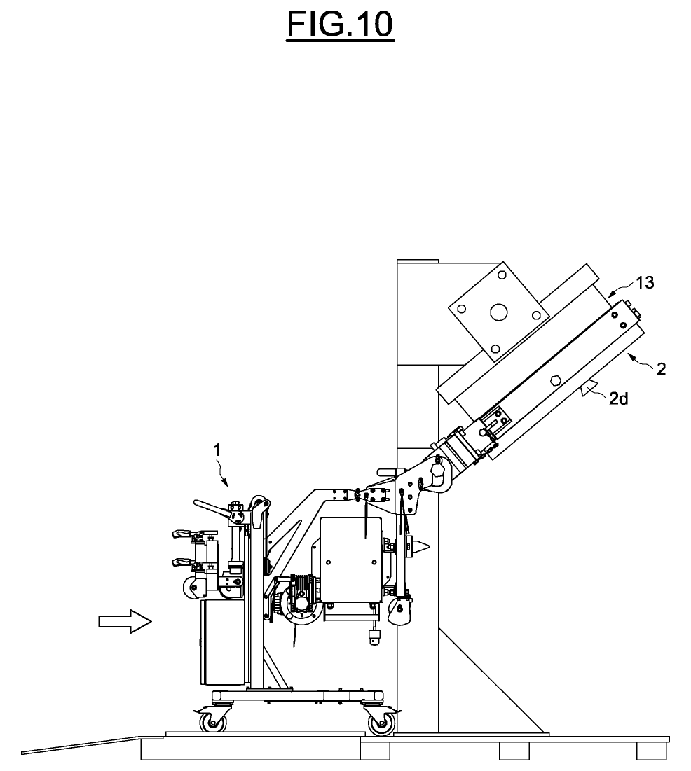

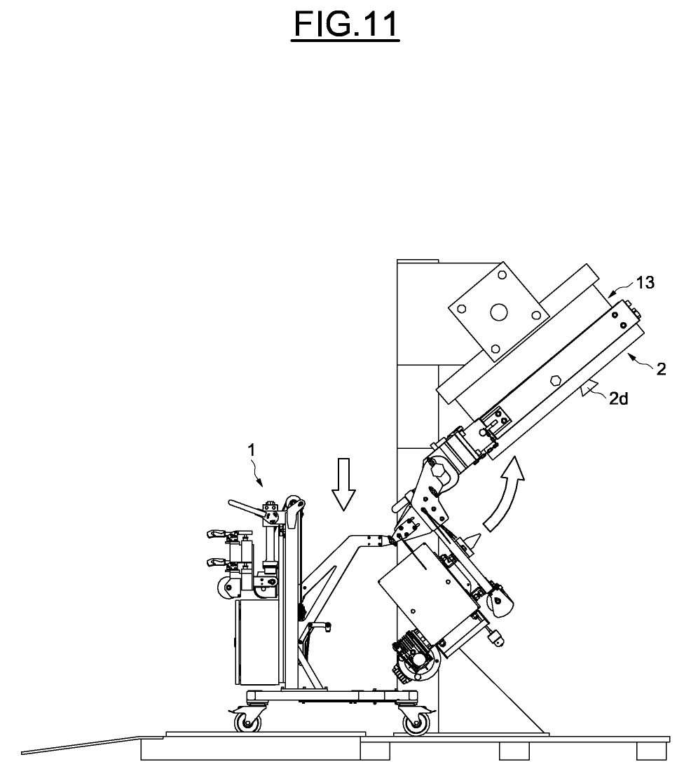

At step 32, the winch assembly 6 is hung on the cover axle 2a using the hooks 9 (FIG. 10). Step 32 includes lowering the winch assembly 6 to a free hanging point (FIG. 11).

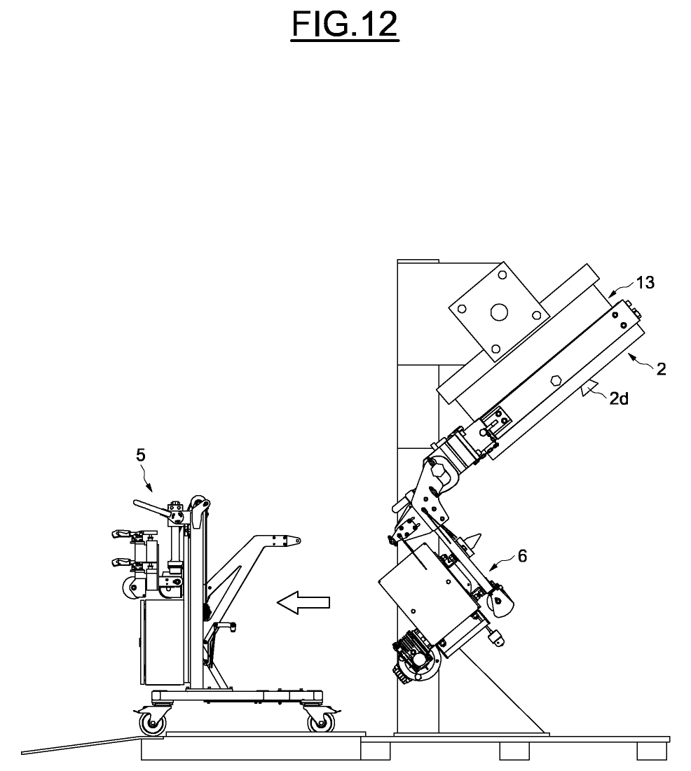

At step 33, the winch assembly 6 is detached from the hand trolley assembly 5. Once the winch assembly 6 is detached, the hand trolley assembly 5 can be pulled back to a clear area as shown in FIG. 12.

While the short-term fastening of the cover 2 are in place, the wires 8 are pulled through the first through holes 2b of the cover 2 and the anchors 10 are threaded to the inner threads 11 of the second holes 12 of the base plate 13 with the screwing tool (step 34). Preferably, the wires 8 are guided through the wire guiding means 22, for example by rolling on the jockey wheels 23.

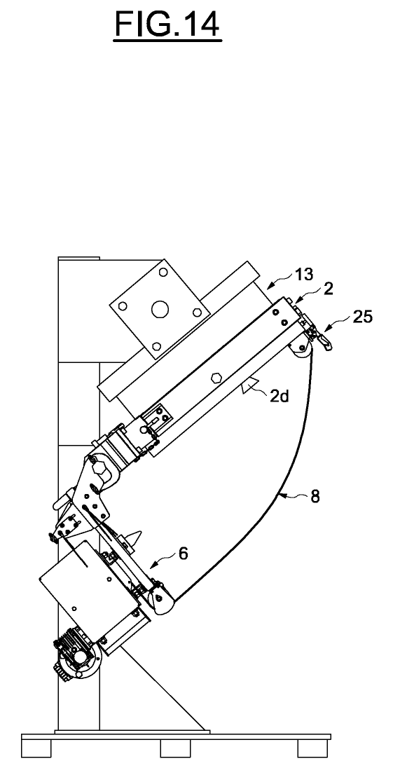

Preferably, at step 34 or immediately after, the cover wire guide 25 is inserted in the first through holes 2b of the cover 2 so that the wires 8 are guided by the rollers 25c, 25d. The cover wire guide 25 is then clamped on the cover 2 (FIG. 14).

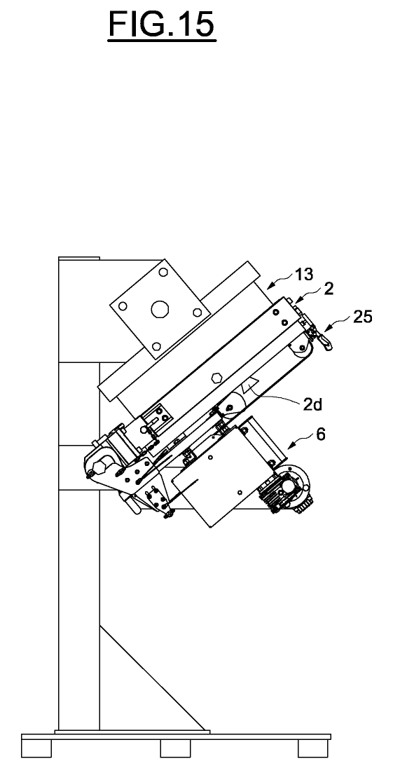

At step 35, the wires 8 are tensioned by winding them up to lift the winch assembly 6 to the cover 2 until the winch assembly 6 engages the cover 2 as shown in FIG. 15. The tensioning of the wires 8 is done using the winch 7. For example, the winch assembly 6 engages the cover when the location cones 16 are fully inserted in the second through holes 17 and the base plates 16a contact the outer face 2c of the cover 2.

At step 36, the cover 2 is completely unfastened from the base plate 13, by removing the short-term fastening, preferably the two centering tools 2d.

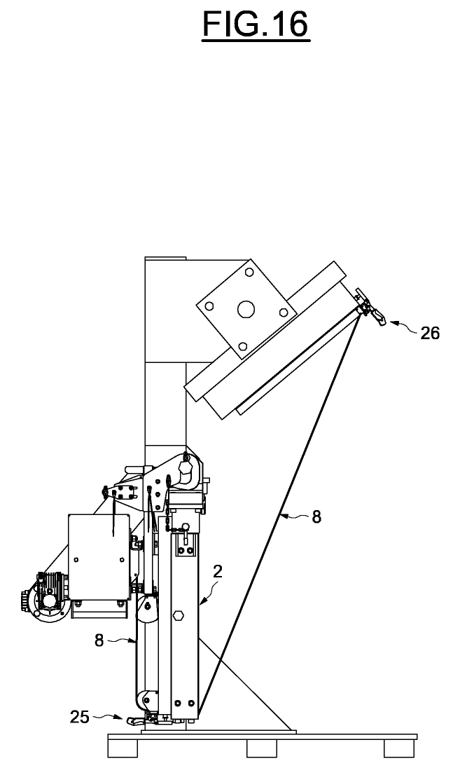

After the complete unfastening of the cover 2, the wires 8 are unwound to lower the cover 2 until reaching a neutral hanging point shown in FIG. 16 and corresponding to the open cover position (step 37). It is to be noted that at step 37, the base plate wire guide 26 is installed on the base plate 13 to prevent any unwanted contact between the wires 8 and the base plate 13. In order to ease the installation, the base plate wire guide 26 is installed in an installation position in which the wires 8 are essentially parallel to the bores of the holes 2b, and in which the distance between the cover 2 and the base plate 13 leaves enough room for comfortably inserting the base plate wire guide 26. For example, this installation position is reached when the cover 2 forms an angle about 15° in respect to the base plate 13.

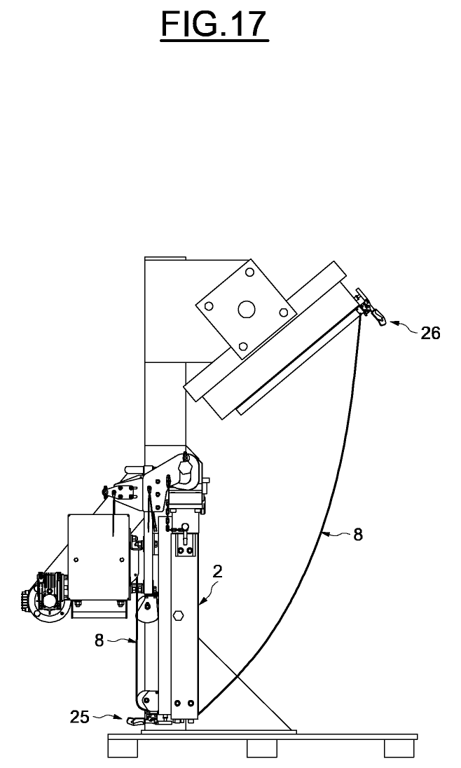

After the cover 2 reaches the neutral hanging point, the wires 8 are wound out or unwound to full de-tensioning (FIG. 17). The wire guides 25, 26 are then removed from the cover 2 and the base plate 13. Then, the anchors 10 are removed from the base plate 13 with the screwing tool and the wires 8 are wound up on the winch 7 to a complete rolled position (step 38).

When the wires 8 are in the complete rolled position on the winch 7, the winch assembly 6 is removed with the hand trolley assembly 5 (step 39).

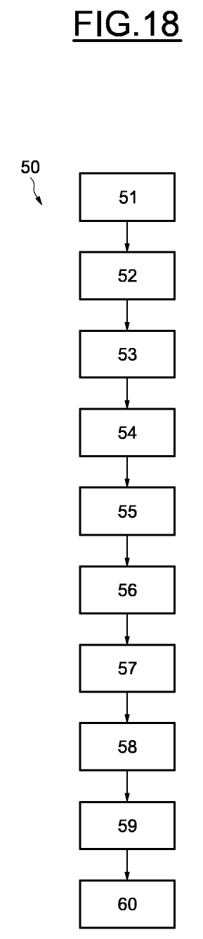

FIG. 18 is a flow diagram illustrating a method 50 for closing an open swinging cover 2 using the manipulator 1 described above.

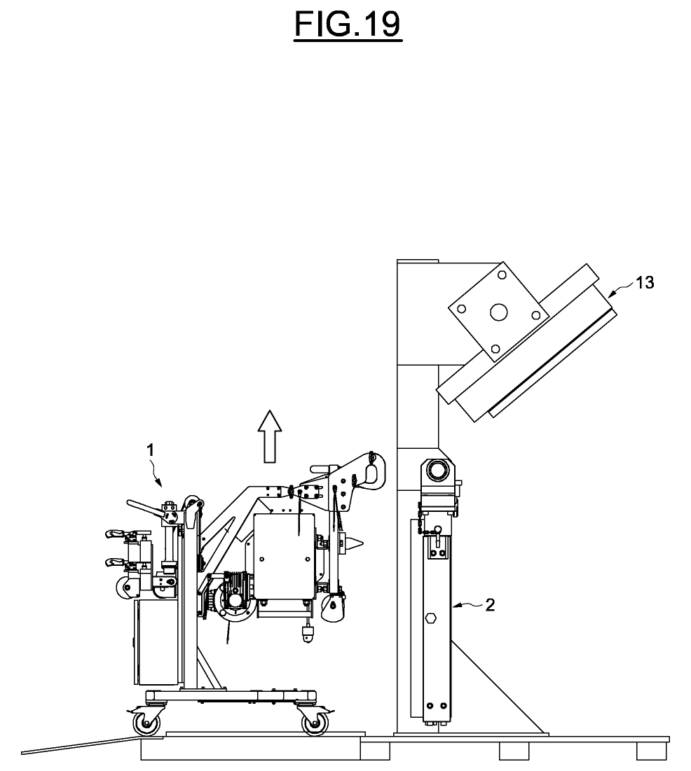

At step 51, the manipulator 1 approaches, or is positioned proximal to, the open cover 2. Step 51 includes hoisting the winch assembly 6 to the high position with the lifting means 18 (FIG. 19).

At step 52, the winch assembly 6 engages the cover 2. For example, the winch assembly 6 engages the cover when the location cones 16 are fully inserted in the second through holes 17 and the base plates 16a contact the outer face 2c of the cover 2.

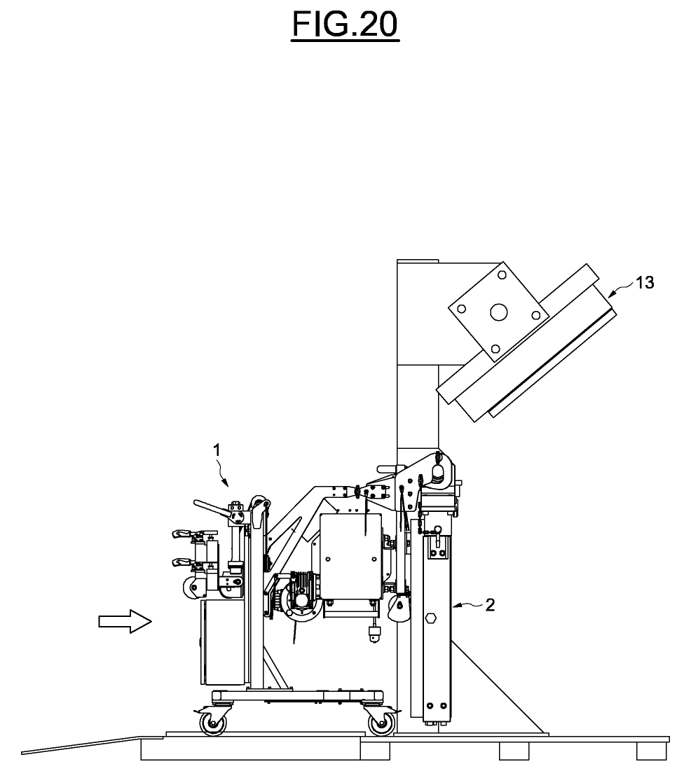

At step 53, the winch assembly 6 is hung on the cover axle 2a as shown in FIG. 20.

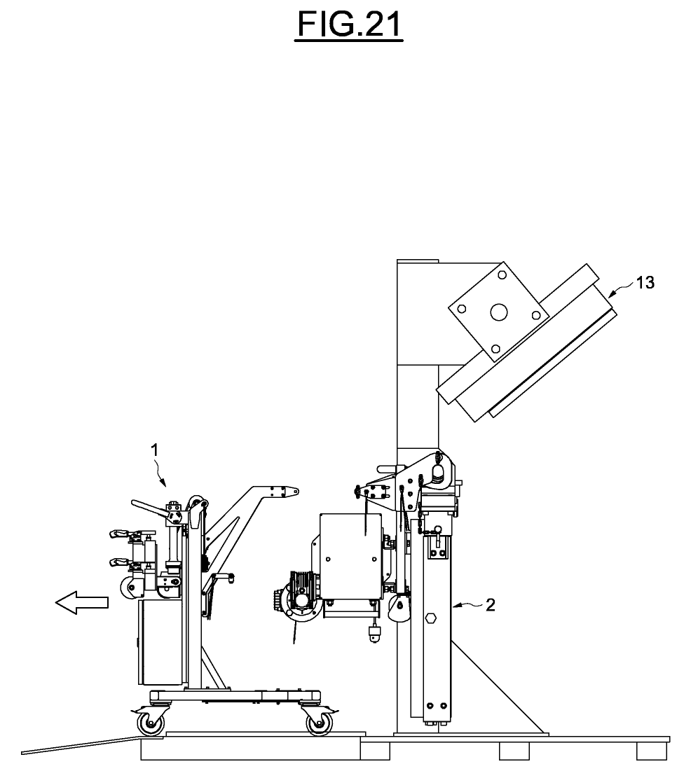

At step 54, the winch assembly 6 is detached from the hand trolley assembly 5. Once the winch assembly 6 is detached, the hand trolley assembly 5 can be pulled back to a clear area as shown in FIG. 21.

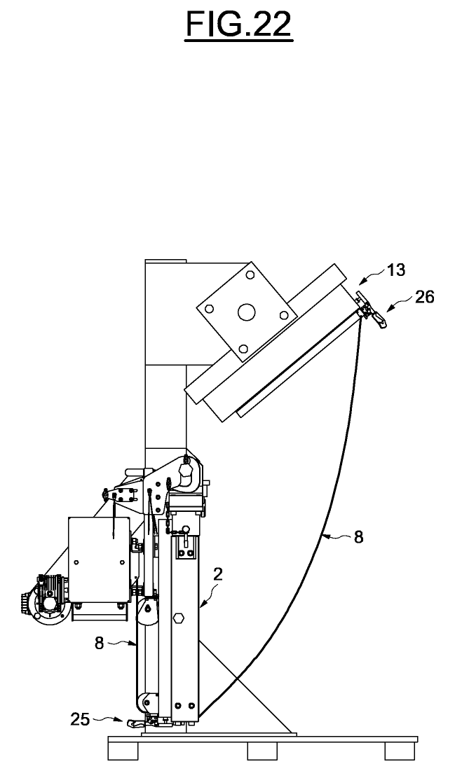

At step 55, the wires 8 are pulled through the first through holes 2b of the cover 2 and the anchors 10 are threaded to the inner threads 11 of the second holes 12 of the base plate 13 with the aid of the screwing tool. At step 55, the wires 8 are guided through the wire guiding means 22, for example by rolling on the jockey wheels 23. At step 55, the cover wire guide 25 and the base plate wire guide 26 are installed respectively on the cover 2 and the base plate 13 (FIG. 22).

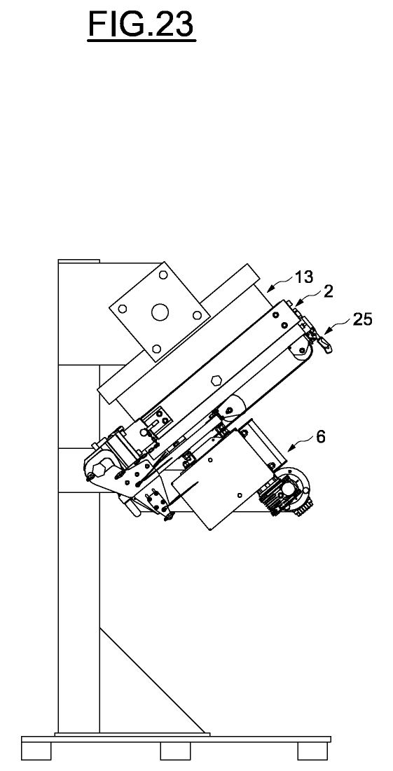

At step 56, the wires 8 are tensioned by winding to lift the cover 2 to the closed cover position shown in FIG. 23. In order to allow the cover 2 to reach the closed cover position, the base plate wire guide 26 is removed as soon as there is no risk of unwanted contact between the wires 8 and the base plate 13. For example, the base plate wire guide 26 is removed when the cover 2 forms an angle of about 15° with the base plate 13. In this position, the wires 8 are essentially parallel to the bores of the holes 2b, and the distance between the cover 2 and the base plate 13 leaves enough room for comfortably or safely removing the base plate wire guide 26.

At step 57, the cover 2 is momentarily fastened to the base plate 13 with the aid of short-term fastening tools, preferably with two centering tools 2d as shown in FIG. 13.

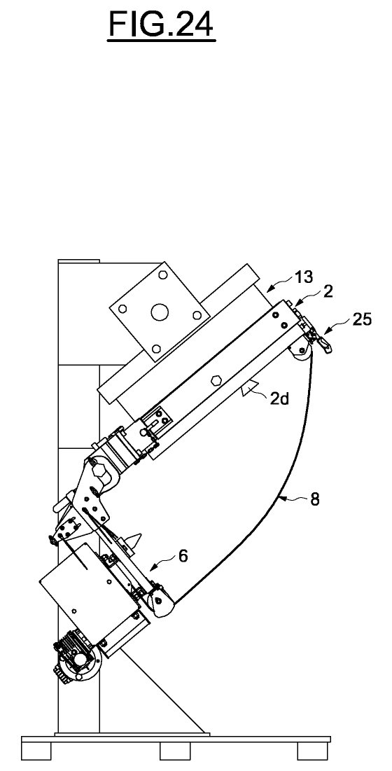

At step 58, the wires 8 are winding out to full de-tensioning with the aid of the winch 7 to lower the winch assembly 6 to a neutral hanging point as shown in FIG. 24.

At step 59, the cover wire guide 25 is removed from the cover 2 and then, the anchors 10 are removed from the base plate 13 with the screwing tool and the wires 8 are retracted on the winch 7.

After the wires 8 are retracted on the winch 7, the winch assembly 6 is removed with the hand trolley assembly 5 (step 60).

At step 61, the cover is fastened with long-term fastenings and all the short-term fastenings installed at step 57 are replaced with long-term fastenings.

While the invention has been described particularly with regard to swingable covers for steam generators, it will be appreciated that the invention or various aspects thereof as described may advantageously be used in other areas where a controlled opening and closing of heavy covers is needed.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

I claim:

1. A manipulator for opening and closing a swinging cover for a manhole of a steam generator, the manipulator comprising:
a hand trolley assembly; and
a winch assembly engageable with the swing cover and detachably mounted to the hand trolley assembly, the winch assembly including a winch provided with a pair of wires, a pair of hooks configured to hang the winch assembly on an axle of the swinging cover and two threaded anchors, each threaded anchor being attached to an end of one of the wires and being configured to pass through a first through hole of the swinging cover and to be threaded into a second threaded hole provided on a base plate of the steam generator so as to provide a support point for the associated wire, the winch being adapted to wind and alternatively unwind the two wires so as to rotate the swinging cover between a closed cover position in which the first through hole is aligned with the second hole and an open cover position in which the swinging cover is at a neutral hanging point.

2. The manipulator according to claim 1, wherein the winch assembly further includes location means configured to cooperate with associated receiving means provided on the swinging cover so as to ensure a correct position of the winch assembly with respect to the swinging cover.

3. The manipulator according to claim 2, wherein the location means includes a pair of location cones and the receiving means includes a pair of second through holes provided between the axle and the first through holes, each location cone being insertable into a separate one of the pair of second through holes.

4. The manipulator according to claim 1, wherein each hook includes a body and a rotatably mounted jaw movable between an open position and a closed position, the body and the jaw defining an oblong transverse opening when the jaw is in the closed position.

5. The manipulator according to claim 1, further comprising wire guiding means associated with each one of the wires.

6. The manipulator according to claim 5, wherein the wire guiding means include a pair of jockey wheels associated with each one of the wires and provided on a frame of the winch assembly.

7. The manipulator according to claim 5, wherein the wire guiding means include a cover wire guide detachably mounted on the cover and a base plate wire guide detachably mounted on the base plate.

8. The manipulator according to claim 1, wherein the hand trolley assembly is provided with lifting means adapted to vertically displace the winch assembly.

9. A method for opening a closed swinging cover with a manipulator according to claim 1, the method comprising the steps of:
positioning the manipulator proximal to the cover axle;
hanging the winch assembly on the cover axle;
detaching the winch assembly from the hand trolley assembly;
pulling the wires through the cover and threading the anchors to the base plate;
winding the wires to lift the winch assembly to the cover until the winch assembly engages the cover;
unfastening the cover from the base plate;
unwinding the wires to lower the cover until reaching a neutral hanging point corresponding to an open cover position;
unwinding the wires to full de-tensioning and removing the anchors from the base plate and winding up the wires on the winch; and
removing the winch assembly with the hand trolley assembly.

10. A method for closing an open swinging cover with a manipulator according to claim 1, the method comprising the steps of:
positioning the manipulator proximal to the cover;
engaging the cover with the winch assembly;
hanging the winch assembly on the cover axle;
detaching the winch assembly from the hand trolley assembly;
pulling the wires through the cover and threading the anchors to the base plate;
winding the wires so as to lift the cover to the closed cover position;
fastening the cover to the base plate in the closed cover position with temporary fasteners;
unwinding the wires to full de-tensioning so as to lower the winch assembly from the cover;
removing the anchors from the base plate and retracting the wires on the winch;
removing the winch assembly with the hand trolley assembly; and
fastening the cover to the base plate with long-term fasteners.
